(19) United States
(12) Patent Application Publication
(10) Pub. No.: US 2004/0199425 A1
(43) Pub. Date: Oct. 7, 2004

(54) Method and apparatus for motion-controlled communication of offers

(76) Inventors: Andrew S. Van Luchene, Santa Fe, NM (US); Raymond J. Mueller, Weston, CT (US); David E. Brady, Stamford, CT (US)

Correspondence Address: WALKER DIGITAL, FIVE HIGH RIDGE PARK, STAMFORD, CT, 06905, US

(21) Appl. No.: 10/800,476

(22) Filed: Mar. 15, 2004

Related U.S. Application Data
(60) Provisional application No. 60/455,219, filed on Mar. 14, 2003.

(51) Int. Cl. G06F 17/60

(52) U.S. Cl. 705/15

(57) ABSTRACT

A method according to one embodiment of the present invention provides for controlling output of an offer at a menu board of a drive-through. An offer is determined and output to a customer at the menu board. If it is determined that the customer has moved away from the menu board, output of the offer is discontinued. In some embodiments, the same or a different offer may be output to the customer at a different station of the drive-through (e.g., a payment or pick-up window).

The present Application claims the benefit of U.S. Provisional Patent Application Serial No. 60/455,219, filed Mar. 14, 2003, entitled “MOTION SENSOR CONTROLLED SUGGESTIVE SELLING SYSTEM,” the entirety of which is incorporated by reference herein for all purposes.

### CROSS-REFERENCE TO RELATED APPLICATIONS

The present Application is related to each of the following commonly-owned, co-pending U.S. Patent Applications:

(i) U.S. patent application Ser. No. 10/770,385, filed Feb. 2, 2004, entitled “DIGITAL ADVERTISEMENT BOARDS IN COMMUNICATION WITH POINT-OF-SALE TERMINALS”;

(ii) U.S. patent application Ser. No. 10/403,184, filed Mar. 28, 2003, entitled “METHOD AND APPARATUS FOR MANAGING AND PROVIDING OFFERS”;

(iii) U.S. patent application Ser. No. 10/124,697, filed Apr. 16, 2002, entitled “METHOD AND APPARATUS FOR MAINTAINING A CUSTOMER DATABASE USING LICENSE PLATE SCANNING”;

(iv) U.S. patent application Ser. No. 09/993,228, filed Nov. 14, 2001, entitled “METHOD AND APPARATUS FOR DYNAMIC RULE AND/OR OFFER GENERATION”; and

(v) U.S. patent application Ser. No. 09/603,677, filed Jun. 26, 2000, entitled “METHOD AND APPARATUS FOR SELECTING A SUPPLEMENTAL PRODUCT TO OFFER FOR SALE DURING A TRANSACTION.”

The entirety of each of the related Applications above is incorporated by reference herein for all purposes.

### BACKGROUND

Many quick-service restaurants and other types of businesses have a “drive-through” or “drive-thru” system that allows a customer to place an order, to receive ordered items, and/or to submit payment for an order, without exiting her vehicle. A typical drive-through includes a roadway equipped with a speaker and a microphone to allow a customer in a vehicle to interact with a cashier operating a remote point-of-sale (POS) terminal. Many drive-throughs include a motion sensor or other type of detector so that an employee in the restaurant can be alerted when a customer drives into the drive-through. A drive-through allows customers to make purchases more conveniently, and consequently businesses with drive-throughs tend to promote customer satisfaction and customer loyalty.

Some types of retailers find it desirable to make upsells (and/or other types of suggestive offers or promotions) to customers once they have placed an order. For example, some quick serve restaurants may use this type of suggestive selling at an inside counter and/or in a drive-through. One of the operators' biggest concerns is speed of service time. Many operators want to suggestively sell to every customer, but not if doing so means it will take too long for orders to be placed or completed. This may be of particular concern at a drive-through.

Many customers who use a drive-through (e.g., at a quick serve restaurant) are used to driving forward (e.g., to a pick-up window) immediately after placing an order at the menu board. Consequently, an upsell output at a drive-through menu board (e.g., via a speaker and/or display) after an order is placed might not be heard or seen by the customer who has already driven on to pick up the order.

Some types of suggestive selling systems allow a cashier to decline an upsell before a customer can see or hear it. In order to prevent cashiers from declining upsells in this manner, before a decline of an offer can be registered, some types of suggestive selling systems allow the system to display an upsell (e.g., on a screen) for a prescribed period of time and/or to finish speaking the upsell. This functionality ensures that a customer will see and/or hear an upsell, even if a cashier declines (or attempts to decline) the upsell. However, because a suggestive selling system might be configured to continue making an upsell to a customer (e.g., for a predetermined period of time), the next customer may hear and/or see an upsell that was intended for the customer in front of them. For example, if a first customer places his order at a drive-through menu board and immediately drives forward, the next customer who pulls up to the menu board might hear the upsell intended for the previous customer. This might be confusing or frustrating for the second customer, and might have a negative impact on speed of service (e.g., if the second customer must wait until the offer is completed to place his order).

### BRIEF DESCRIPTION OF THE FIGURES

FIG. 1 shows a block diagram of a system that is consistent with at least one embodiment of the present invention.

FIG. 2 shows a block diagram of a server that is consistent with at least one embodiment of the present invention.

FIG. 3 is a table illustrating an exemplary data structure of a point-of-sale database consistent with at least one embodiment of the present invention.

FIG. 4 is a table illustrating an exemplary data structure of an offer database consistent with at least one embodiment of the present invention.

FIG. 5 is a table illustrating an exemplary data structure of a transaction database consistent with at least one embodiment of the present invention.

FIG. 6 is a flowchart of an exemplary process that is consistent with at least one embodiment of the present invention.

FIG. 7 is a flowchart of an exemplary process that is consistent with at least one embodiment of the present invention.

### DETAILED DESCRIPTION

Applicants have recognized that there are numerous advantages to providing for managing the determination, dissemination, and display of various types of retail information (e.g., prices, inventory, menus, offers) among any number of point-of-sale, order entry, display and/or audio devices in a retail environment (e.g., a retail store, a quick service restaurant).

Applicants have also recognized that it would be advantageous, in accordance with some embodiments of the present invention, to provide for a system that allowed for controlling the communication of offers based on the location and/or movement of a customer in an ordering process (e.g., in a quick serve restaurant). In addition, it would be advantageous, in some embodiments, to provide for a system that allowed for initiating and/or terminating the output of offers based on the detected presence and/or absence of a customer. For example, it would be advantageous to provide for a system that improved control of the output of offers to a customer in a retail drive-through (e.g., based on the detected presence (or absence) of that customer).

Some embodiments of the present invention allow a system for providing offers to discontinue making an upsell (e.g., via video and/or audio). For example, output of an upsell at a menu board, pick-up window, or other station of a drive-through, may be discontinued (or even suppressed) if a customer has already driven away from that location. Some operators may find such embodiments appealing, particularly if a cashier does not have the ability to discontinue, suppress, or interrupt the upsell.

At least one embodiment of the present invention provides for outputting an offer at a first station (e.g., a drive-through menu board or other type of ordering station) and for repeating the same offer (e.g., via a display device and/or audio device) at one or more other stations (e.g., a pick-up window, a station for tendering payment). For example, if an upsell offer displayed using a digital menu board is declined by a customer, it can be displayed again using a display device at a pick-up window (or other station at which the customer receives his order). In another example, an offer that is not completed, or is missed by a customer when presented at an ordering station, could be output again when the customer is at a pick-up window. For instance, if a drive-through customer drives away from a menu board before an upsell is output or before the presentation of the upsell is completed, the upsell may be provided again using a speaker located at the pick-up window.

At least one embodiment of the present invention provides for outputting an offer at a first station (e.g., a drive-through menu board or other type of ordering station) and for providing a different offer (e.g., via a display device and/or audio device) at one or more other stations (e.g., a pick-up window, a station for tendering payment). For example, if an upsell offer displayed using a digital menu board is declined by a customer, a different offer can be output using an audio speaker at a subsequent station (e.g., a pick-up window). In another example, if a first offer is not completed, or is missed by a customer at an ordering station, a different offer could be output when the customer is at a payment station. In some embodiments, information about the first offer and/or the customer's decline of the first offer may be used to determine the second offer to present.

At least one embodiment of the present invention provides for outputting an offer to a customer using a first device (e.g., a display screen component of a menu board) and for repeating the same offer to the customer using a second device (e.g., via a display device and/or audio device at a pick-up window). In other embodiments, a second device is used to output a different offer.

Some embodiments of the present invention provide for detecting that a customer has moved away from a location or is no longer at the location, and terminating or suppressing the output of an offer (e.g., an upsell offer) at that location. As discussed further herein, the offer may be repeated (e.g., at a different location).

Some embodiments provide for detecting that a customer is at a particular location, and outputting a greeting or offer in response to detecting the customer's presence. For example, a customer arriving at a station where her food order is delivered may be presented with an advertisement, marketing information, upsell offer, summary of her order, indication of a purchase amount, and/or an indication of an amount of change due she is due.

In some embodiments, detecting a customer, determining that a customer is at a particular location, determining that a customer has left or is not at a particular location, and/or determining that a customer is proximate an output device, menu board, or restaurant station (e.g., a drive-through ordering or pick-up station), may include detecting a vehicle or receiving an indication of a vehicle. For example, as will be readily understood, a typical drive-through includes at least one device for indicating the presence of a vehicle.

Various embodiments of the present invention are described herein with reference to the accompanying drawings. The leftmost digit(s) of a reference numeral typically identifies the figure in which the reference numeral first appears.

### 1. System

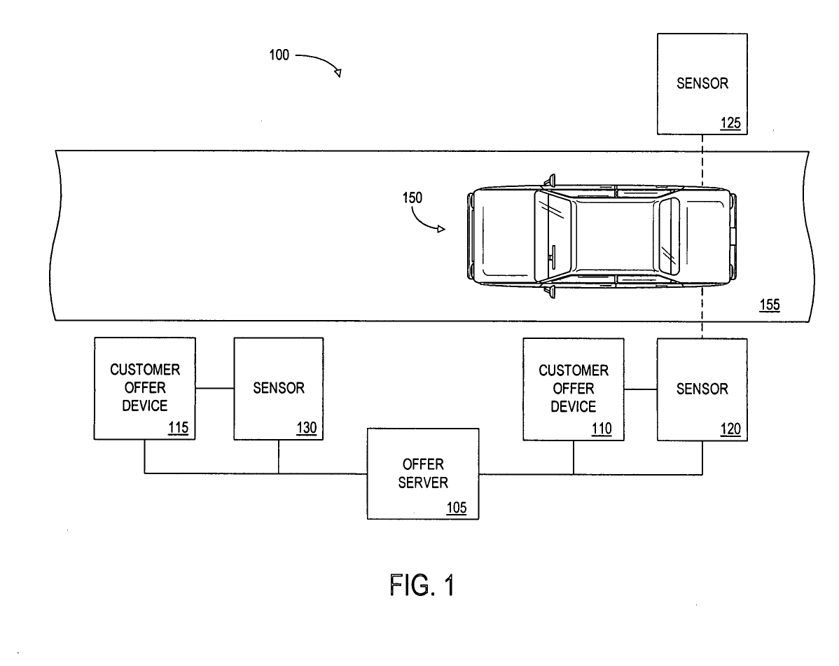

Referring now to FIG. 1, a system 100 according to one or more embodiments of the present invention includes an offer server 105 that is in communication with one or more devices, such as one or more customer offer devices 110, 115, and one or more sensors 120, 125, 130.

As described in further detail herein, the offer server 105 (e.g., a point-of-sale (POS) server or a controller that fulfills various in-store POS or back office server duties) is operable to manage and/or optimize the distribution and display of offer, product, menu, and/or advertising information. For example, the offer server 105 for a restaurant may manage the communication of offer information to customers (e.g., using one or more menu boards, display screens, speakers, POS terminal cashier displays, or other types of devices operable for outputting offers).

In various embodiments, the offer server 105 (or, in an alternative embodiment, a peer-to-peer network) can control whether an offer will be made at a given time, determine what an offer for a particular item will be, determine what an offer for a particular customer will be, determine whether to suppress or discontinue output of offer information, determine where and how offer information will be displayed, and/or collect transaction data for future use such as optimization of item offerings and display (or sharing such data among multiple locations).

The offer server 105 may communicate with the devices 110, 115, 120, 125, 130 directly, via a network such as a Local Area Network (LAN), the Internet or via any other communication technology, as is well known in the art. Each of the devices 110, 115, 120, 125, 130 may comprise computers, such as those based on the Intel® Pentium® processor, that are adapted to communicate with the offer server 105. Any number of such devices may be in communication with the offer server 105. Further, those of skill in the art will understand that any of the devices 110, 115, 120, 125, 130 may be omitted, in various embodiments of the present invention.

Communication between the devices 110, 115, 120, 125, 130 and the offer server 105 may be direct or indirect, such as over the Internet through a Web site maintained by offer server 105 on a remote server, or over an on-line data network including commercial on-line service providers, bulletin board systems and the like. In yet other embodiments, the devices may communicate with offer server 105 over radio frequency (RF) signals, cable television signals, satellite communication links and the like.

In some embodiments, the offer server 105 may be in communication with one of the devices indirectly via another device. For example, the offer server 105 may be in communication with the customer offer device 115 only indirectly via the sensor 130 (or vice versa).

Those skilled in the art will understand that devices in communication with each other need not be continually transmitting to each other. To the contrary, such devices need only transmit to each other as necessary, and may actually refrain from exchanging data most of the time. For example, a device in communication with another device via the Internet may not transmit data to the other device for weeks at a time.

The offer server 105 may function as a “Web server” that generates Web pages (documents on the Web that typically include an HTML file and associated graphics and script files) that may be accessed via the Web and allows communication with the offer server 105 in a manner known in the art.

Any or all of the devices 110, 115, 120, 125, 130 may be, e.g., conventional personal computers, portable types of computers, such as a laptop computer, a palm-top computer, a hand-held computer, or a Personal Digital Assistant (PDA), or they may be specialized devices built for specific purposes such as environmentally-hardened displays for use in a drive-through, or POS terminals with separate or integrated customer LCDs or similar displays.

The customer offer devices 110, 115 may be a personal computer or other device that allows a customer to receive offers and/or provide responses to offers. The customer offer devices 110, 115 could also be, e.g., a vending machine, a slot machine or any other device that interacts with customer. The customer offer devices 110, 115 could also include a device that allows a customer to view price information and/or advertisements and could be, for example, an electronic display of a vending machine, a slot machine, or any other device useful for providing product information and/or advertising to customers.

The customer offer devices 115, 120 may be one or more screens, such as a flat panel monitor or cathode ray tube monitor, that are capable of displaying visual information such as images, text and video. The customer offer devices 115, 120 may include an audio output means, such as a speaker, which generates sounds (e.g. synthetic speech, recorded voice or other sounds) as directed by the offer server 105.

The customer offer devices 115, 120 may include a printer, such as one that prints receipts or coupons, which prints as directed by the offer server 105. Accordingly, the customer offer devices 115, 120 can provide offers in displayed, audio and/or printed form.

The customer offer devices 115, 120 may include a touch screen overlaid on a monitor and capable of receiving manual input from a customer. The customer offer devices 115, 120 may include other known input devices, such as a microphone for voice input, a keyboard, a stylus, a pen reader, a radio frequency receiver (e.g., for detecting signals from cellular telephones or other transmitting devices) and/or a card reader.

In some embodiments, a customer offer device 110, 115 is associated with (e.g., in communication with, driven by, a peripheral of) a point-of-sale terminal. However, offers may even be provided by, e.g., stations, which are not currently serving customers, such as a display device associated with an unmanned POS terminal. In some exemplary embodiments, a customer offer device 110, 115 is located at a retailer's drive-through and/or in front of a service counter (e.g., for use by customers in reviewing and/or accepting offers). In some embodiments, a customer offer device 110, 115 is associated with (e.g., in communication with, driven by, a peripheral of) a customer self-ordering station or kiosk.

In some embodiments, a customer offer device 110, 115 is associated with (e.g., in communication with, driven by, a peripheral of) a drive-through menu board. For example, the customer offer device 110 may be part of a drive-through ordering station visible and/or accessible by a particular customer (e.g., for using a touch screen) when placing an order (e.g., by making selections from a menu board).

The customer offer device 110, 115 may include (or be a component of) a digital menu board or other type of electronic display device that is operable to display to customers, among other things, product names and corresponding prices and/or advertisements or promotions for various types of goods and services. Exemplary menu/advertisement display devices include those manufactured by Epicure Digital™.

A menu board may comprise one or more types of display devices such as, without limitation, plasma screens, televisions, projection systems (e.g., LCD projection screen), LCD screens, cathode ray monitors, and various combinations thereof, that are capable of displaying visual information such as images, text and video.

According to some embodiments, the customer offer device 110 is a menu board in communication with the offer server 105 or other merchant server (e.g., a POS server) and is operable to display items which may be ordered and corresponding prices for the displayed items, as commanded by the offer server 105. The menu board may be positioned to allow drive-through customers to view the menu board display before (or while) ordering in the drive-through. A speaker and a microphone may be operable to allow drive-through customers to communicate with store personnel, such as cashiers operating POS terminals, who operate respective speakers and microphones for talking to and listening to the drive-through customers in a manner known in the art.

Various types of sensors 120, 125, 130 for sensing the presence or absence of a customer are well known to those skilled in the art, and may include, without limitation, a motion sensor, a heat sensor, a weight sensor, a pressure sensor (e.g., a pressure hose), a light sensor, an audio sensor, a laser, a metal sensor, and a sensor including a magnetic coil. In some embodiments, a sensor may include a device by which an employee of a retail establishment is able to indicate (e.g., based on a visual determination) that a customer is present at (or absent from) a particular location (e.g., at a menu board, at a pick-up window).

According to at least one embodiment, sensors 120, 125, 130 are operable to detect a vehicle. As depicted in FIG. 1, exemplary sensors 120 and 125 are positioned on opposite sides of a roadway 155 (e.g., a drive-through alley for a fast food restaurant). The sensors 120 and 125 are adapted to detect the presence and/or the absence of a vehicle 150 located on the roadway 155. The sensors 120 and 125 may comprise, for example, pressure sensors located beneath the roadway 155 that detect the weight of the vehicle 150. Alternately, sensors 120 and 125 may comprise, respectively, a light transmitter and a receiving photo sensor (an optical detector) that cooperate to detect the presence of the vehicle 150 when the transmitted light is blocked by the vehicle 150 and thus is not received by the receiving photo sensor. Other means for detecting the presence and the absence of a vehicle will be understood by those skilled in the art. Of course, it will also be readily understood by those skilled in the art that a system for sensing a customer need not require two cooperating components, and that components need not be positioned on opposite sides of a roadway.

The system 100 depicted in FIG. 1 is presented by way of example only. For instance, although two customer offer devices 110, 115 and three sensors 120, 125, 130 are depicted in FIG. 1, various embodiments of the present invention may be practiced with only one customer offer device and only one sensor, for example, or any number of customer offer devices and/or sensors. Further, the system 100 depicted in FIG. 1 would be typical of an apparatus for use in a retail environment such as a quick-service restaurant or grocery store. However, the present invention is not limited to such components and may be used in other environments.

For example, the offer server 105 may be in communication with customers via telephones and an Interactive Voice Response Unit. Thus, a customer may hear audio output from the offer server 105 via a telephone (e.g., while on hold with the merchant or a different merchant), and communicate with the offer server 105 via voice or by pressing buttons on the telephone.

The offer server 105 may be a computer involved in operating a physical store. Such a computer, for example, could perform such tasks as inventory management and transaction processing for the store.

The system 100 may alternatively be configured in a multi-tier architecture, as would be apparent to those of skill in the art. The system 100 may also be configured in a peer-to-peer architecture, as would be apparent to those of skill in the art.

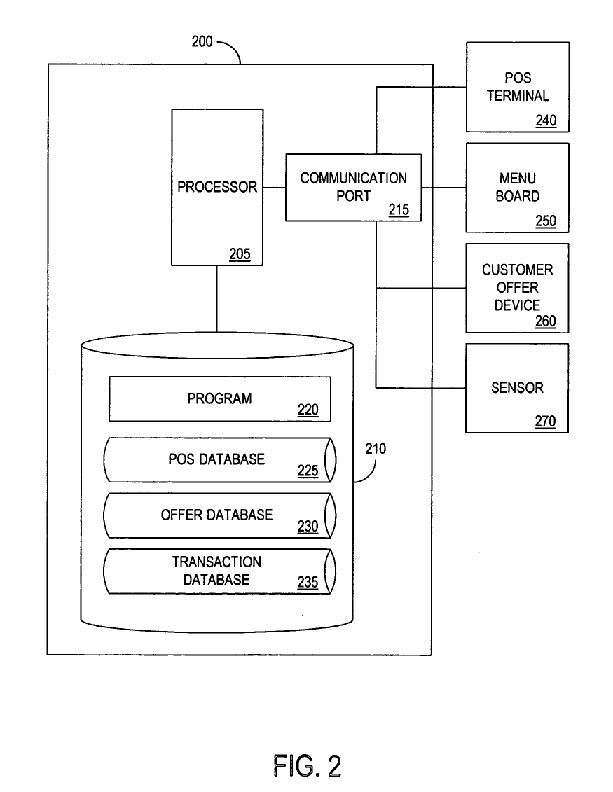

FIG. 2 illustrates an embodiment 200 of the offer server 105 of FIG. 1. The offer server 200 may be implemented as a system controller, a dedicated hardware circuit, an appropriately programmed general purpose computer such as an Intel-based PC, a server computer such as a Sun Fire B100s Blade Server manufactured by Sun Microsystems Inc. or a “Precision Workstation” or “Poweredge 350” manufactured by Dell Computer Corporation, or any other equivalent electronic, mechanical or electromechanical device suited for the volume of transactions and the performance levels desired.

The offer server 200 comprises a processor 205, such as one or more Intel® Pentium® processors. The processor 205 is coupled to a communication port 215 through which the processor 205 communicates with one or more other devices.

The offer server 200 may be in communication with one or more POS terminals 240. The POS terminal 240 may be, for example, the IBM 4683 or IBM 4693 manufactured by International Business Machines. As is known in the art, point-of-sale terminals typically include a display capable of displaying, e.g., text messages intended to be read by a cashier operating the terminal. According to some embodiments of the present invention, the POS terminal 240 may be operable to execute transactions at a drive-through and may be in communication with a remote ordering station (e.g., a drive-through menu board) either directly or indirectly (e.g., via the offer server 200).

The offer server 200 may be in communication with one or more menu boards 250, one or more customer offer devices 260, and one or more sensors 260. Various types of menu boards, customer offer devices, and sensors are discussed herein, and other types may be readily apparent to those skilled in the art in light of the present disclosure.

The processor 205 is also in communication with a data storage device 210. The data storage device 210 comprises an appropriate combination of magnetic, optical and/or semiconductor memory, and may include, for example, Random Access Memory (RAM), Read-Only Memory (ROM), a compact disc and/or a hard disk. The processor 205 and the storage device 210 may each be, for example: (i) located entirely within a single computer or other computing device; or (ii) connected to each other by a remote communication medium, such as a serial port cable, telephone line or radio frequency transceiver. In one embodiment, the offer server may comprise one or more computers that are connected to a remote server computer for maintaining databases.

The data storage device 210 stores a program 220 for controlling the processor 205. The processor 205 performs instructions of the program 220, and thereby operates in accordance with the present invention, and particularly in accordance with the methods described in detail herein. The program 220 may be stored in a compressed, uncompiled and/or encrypted format. The program 220 furthermore includes program elements that may be necessary, such as an operating system, a database management system and “device drivers” for allowing the processor 205 to interface with computer peripheral devices. Appropriate program elements are known to those skilled in the art, and need not be described in detail herein.

According to an embodiment of the present invention, the instructions of the program 220 may be read into a main memory from another computer-readable medium, such as from a ROM to a RAM. Execution of sequences of the instructions in program 220 causes processor 205 to perform the process steps described herein. In alternative embodiments, hard-wired circuitry may be used in place of, or in combination with, software instructions for implementation of the processes of the present invention. Thus, embodiments of the present invention are not limited to any specific combination of hardware and software.

The storage device 210 also stores (i) a POS database 225, (ii) an offer database 230, and (iii) a transaction database 235. The databases are described in detail below and depicted with exemplary entries in the accompanying figures.

As will be understood by those skilled in the art, the schematic illustrations and accompanying descriptions of the databases presented herein are exemplary arrangements for stored representations of information. A number of other arrangements may be employed besides those suggested by the tables shown. Similarly, the illustrated entries of the databases represent exemplary information only; those skilled in the art will understand that the number and content of the entries can be different from those illustrated herein. Further, despite the depiction of the databases as tables, an object-based model could be used to store and manipulate the data types of the present invention and likewise, object methods or behaviors can be used to implement the processes of the present invention.

Note that, although these databases are described as being stored in an offer server, in other embodiments of the present invention some or all of these databases may be partially or wholly stored in another device, such as one or more of the POS terminals, customer offer devices, menu boards, sensors, self-ordering stations, corporate headquarters servers, or a combination thereof.

Various functionality of the offer server described herein may alternatively be performed by one or more of the customer offer devices 110, 115, 260, the sensors 120, 125, 130, 270, the POS terminal 240, the menu board 250 and/or a remote server or system (e.g., a corporate headquarters server). For example, an appropriately programmed POS terminal or digital menu board system may perform various functions described herein as being performed by the offer server.

In one embodiment, the offer server operates in accordance with one or more databases of rules. Various embodiments of the present invention may be implemented by merely defining and selecting appropriate rules to govern the functionality of the offer server, as will be apparent to those of skill in the art. Such rules can specify, e.g., how to identify transaction slots, how to determine whether to provide an offer during a transaction slot, how to create or select an offer, how to provide the offer.

A rule may specify how to determine whether to provide an offer/advertisement during a transaction and/or during a transaction slot, e.g., by specifying which offers or types of offers may be provided during the transaction slot and/or a maximum number of offers or types of offers which may be provided. A system appropriate for use in accordance with the present invention for, among other things, determining transaction slots, whether to provide an offer to a customer, and/or what type of offer to provide, is disclosed in U.S. patent application Ser. No. 10/403,184, filed Mar. 28, 2003, entitled “METHOD AND APPARATUS FOR MANAGING AND PROVIDING OFFERS,” the entirety of which is incorporated herein by reference as part of the present disclosure.

A rule-based system appropriate for use in accordance with the present invention is disclosed in pending U.S. patent application Ser. No. 09/603,677, filed Jun. 26, 2000, entitled “METHOD AND APPARATUS FOR SELECTING A SUPPLEMENTAL PRODUCT TO OFFER FOR SALE DURING A TRANSACTION,” the entirety of which is incorporated herein by reference as part of the present disclosure.

A rule may specify how to identify a transaction slot (e.g., a customer's presence at a menu board) by identifying one or more transaction events that define the transaction slot (e.g., detection of the customer's vehicle).

A rule may specify how to determine whether to provide an offer during a transaction slot, e.g., by specifying which offers or types of offers may be provided during the transaction slot and/or a maximum number of offers or types of offers which may be provided.

A rule may specify how to create or select an offer, e.g., by specifying performance data such as the expected revenue, profitability and/or accept rate of the offer, expected increase in net profit per second, and/or specifying how the performance data is to be weighed in evaluating offers. Similarly, a rule may specify features of an offer, such as an amount of a discount on an offered product, or the relationship between the amount of a discount and the transaction total, customer identity, type of customer, etc. For example, a rule may specify that a more enticing offer (e.g. one with a greater perceived or actual value) is to be provided to a customer (e.g., at a pick-up window) who has not accepted an offer earlier in the same transaction (e.g., at a menu board) or in previous transactions. Similarly, a rule may specify that an offer with a higher average acceptance rate is to be provided to a customer who has not accepted an offer earlier in the same transaction or in previous transactions.

A rule may specify how to provide the offer, e.g., by specifying whether the offer should be provided via display or speaker and/or specifying which portion of the display the offer should occupy. The offer server may also test a variety of offer locations, types, sizes, and audio types, lengths, voice types, etc., in order to determine which are most effective, individually or collectively.

Further, any of the above-described types of rules may deliberately specify random behavior to both prevent exploitation by customers and to attempt to learn new information, which can be used for subsequent optimization. For example, an offer may be randomly selected and be provided during a random transaction slot.

As is known in the art, a rules-based system may be modified by an adaptive system in order to increase the performance of the rules-based system. An adaptive system which, among other things, may create its own rules and/or modifies rules in accordance with desired performance, and which is appropriate for use in accordance with the present invention is disclosed in pending U.S. patent application Ser. No. 09/993,228, filed Nov. 14, 2001, entitled “METHOD AND APPARATUS FOR DYNAMIC RULE AND/OR OFFER GENERATION,” the entirety of which is incorporated herein by reference as part of the present disclosure. That application discloses an apparatus and method, which permits and enables rules-based applications (such as a system that provides customers with dynamically-priced upsell offers) to become “self improving” and thus increase performance over time.

Such an adaptive system can adjust at least some of the rules in accordance with at least one “reward,” which is a measure of performance. For example, an adaptive system can modify rules such that offers that have previously proven popular when provided after a particular rejected offer are, in subsequent transactions, provided after such rejected offers.

Similarly, the number of available transaction slots could be adjusted by an adaptive system to increase performance as measured by, e.g. transaction time, acceptance rates, etc. For example, fewer offers could be made at a menu board or pick-up window in order to maintain a desired level of speed of service at a drive-through.

Furthermore, the offer might include a discount or deeper discount to increase the likelihood of acceptance. Finally, the system might cease making active offers altogether during a given transaction if it is determined that the customer is unlikely to accept such additional offers.

### 2. Databases

2.1. POS Database

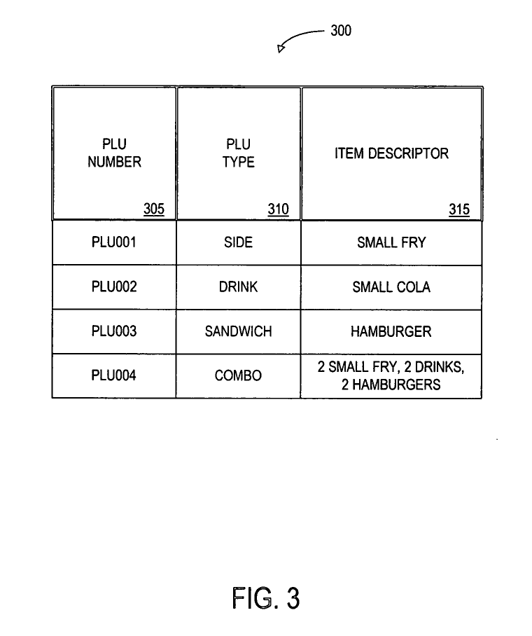

FIG. 3 is a tabular representation 300 of the POS database 225. The tabular representation of the POS database 225 includes a number of example records or entries, each defining a product sold by a retail establishment. Those skilled in the art will understand that the POS database 225 may include any number of entries.

The tabular representation 300 of the POS database 225 also defines fields for each of the entries or records. The fields specify: (i) a product look-up number (PLU#) 305 that uniquely identifies the corresponding product, (ii) a PLU type 310 that indicates the type of product, and (iii) an item descriptor 315 that includes a (preferably text) description of the item.

In some embodiments, the POS database 225 also includes fields indicating display content associated with the corresponding item. For example, a specific record may include an image field that stores an image of the item for use in displaying the item on a digital menu board.

In some embodiments, the offer server 200 may use information stored in the POS database 225 for generating offers. In other embodiments, information in POS database 225 may be used (e.g., by a POS server) for generating the display at a menu board 250 and/or for determining the total of a customer's order.

2.2. Offer Database

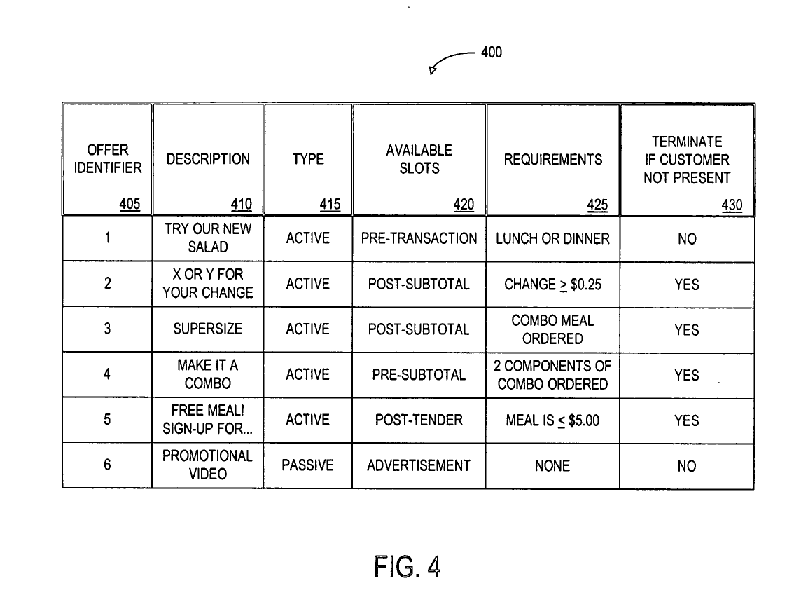

FIG. 4 is a tabular representation 400 of the offer database 230. The tabular representation of the offer database includes a number of example records or entries, each defining an offer that may be or has been provided. Those skilled in the art will understand that the offer database may include any number of entries. The tabular representation of the offer database also defines fields for each of the entries or records. The fields specify: (i) an offer identifier 405, which uniquely identifies the particular offer; (ii) a description 410 of the particular offer; (iii) the type 415 of the particular offer; (iv) the available transaction slots 420 during which the particular offer may be provided; (v) the requirements 425, if any, which must be met for the offer to be provided; and (vi) an indication 430 of whether the particular offer should be terminated if a customer is not present.

The type of offer 415 can, in one embodiment, be either “active” or “passive.” In such an embodiment, an active offer permits or requires a response from the customer. For example, an active offer may require a response from the customer, such as “Which item do you want: an apple pie or a large French fries?” For example, a customer may speak a response into a microphone, touch an appropriate selectable location of a touch screen, speak to an employee, or use any type of input device of a customer offer device to respond to an offer. An active offer may similarly permit, but not require, a response. For example, a display with a touch screen may include a graphical button that, if pressed by the customer, adds a particular product (good and/or service) to the customer's order.

A passive offer does not require a response from the customer but may attempt to solicit one. For example, a passive offer may be an advertisement, which is displayed to the customer, such as an advertisement informing the customer of a particular product.

In some embodiments, the offer database 230 may include additional information about offers, such as the average revenue from providing the particular offer, the average profit from providing the particular offer, the expected take rate (acceptance rate) of the particular offer; and a score of the particular offer, which generally indicates a success rate of providing the particular offer. Such information may be used by the offer server to determine whether and/or when to make the particular offer, for example.

Many types of requirements may be imposed in order for a particular offer to be provided. For example, certain products must be ordered (or, alternatively, not ordered), certain products must be available, a certain change amount or range must be due, the transaction total must be within a particular range, the transaction must occur during a particular time of day or day of the week, and/or the customer must be identified or not identified.

In some embodiments, the indication of whether an offer should be terminated 430 may be used in controlling output of the particular offer, for example, by terminating output of the offer if a customer drives away from a digital menu board or cashier window.

2.3. Transaction Database

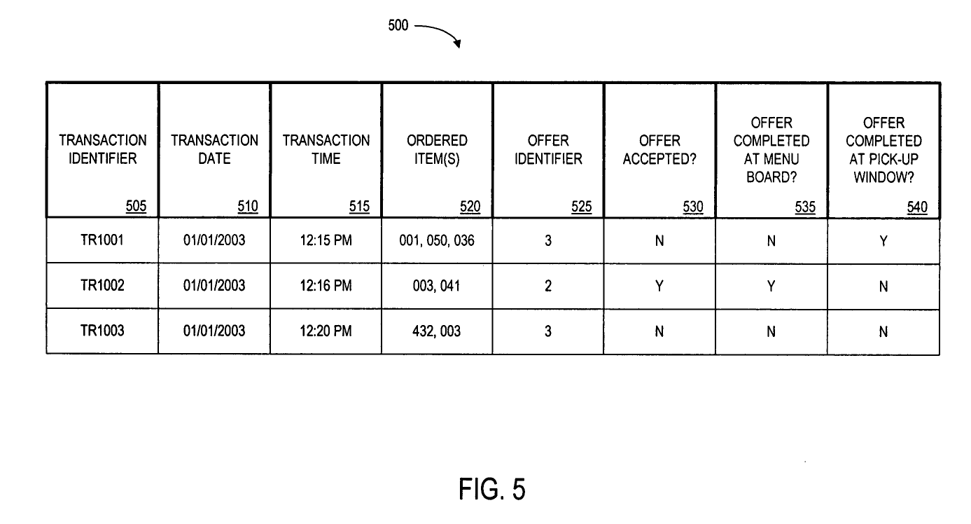

FIG. 5 is a tabular representation 500 of the transaction database 235. The tabular representation of the transaction database includes a number of example records or entries, each defining information about a particular transaction. Those skilled in the art will understand that the transaction database may include any number of entries.

The tabular representation 500 of the transaction database also defines fields for each of the entries or records. The fields specify: (i) a transaction identifier 505 that uniquely identifies the transaction, (ii) a date 510 that indicates a date of the transaction, (iii) a time 515 that indicates a time of the transaction (e.g., start time, end time), (iv) an ordered item(s) 520 that includes an indication of one or more items purchased in the corresponding transaction (e.g., indicated by PLU number), (v) an offer identifier 525 that includes an indication of an offer presented to the customer (e.g., corresponding to an offer identifier 405 in offer database 225), (vi) an offer accepted 530 that indicates whether the offer was accepted, (vii) an offer completed at menu board 535 that indicates whether the output of the offer was completed at a menu board, and (viii) an offer completed at pick-up window 540 that indicates whether output of the offer was completed at a pick-up window.

Of course, it will be readily understood that the time 515 and date 510 may alternatively be represented using a single field including information identifying both the date and time of the transaction.

According to some embodiments, information about whether the offer was accepted and/or information about whether the offer was completed at a particular station may be used by an offer server, for example, in determining whether to repeat output of the same offer (e.g., at a different station) or whether to output a different offer. For example, the exemplary transaction “TR1001” indicates that offer “3” was not completed at the menu board, but was completed at the pick-up window. The customer did not accept the offer.

The data depicted in FIG. 5 is for purposes of example only. It will be readily understood that although FIG. 5 indicates information related to a menu board and to a pick-up window, information about additional and/or alternative types of stations may be stored. For example, information about whether output was completed at a customer self-ordering station could be stored for use in determining whether to repeat output of an offer at an order pick-up window.

### 3. Processes

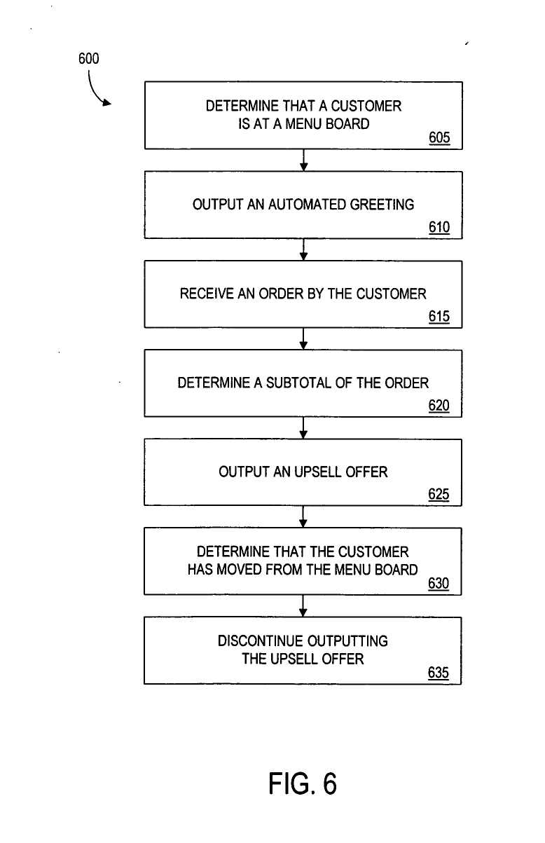

Referring to FIG. 6, a flow chart 600 represents one embodiment of the present invention that may be performed by the system 100 and/or the offer server 105, for example, in controlling the providing of offers in a retail drive-through.

The particular arrangement of elements in the flow chart of FIG. 6, as well as the other flow charts discussed herein, is not meant to imply a fixed order to the steps; embodiments of the present invention can be practiced in any order that is practicable. Also, not all of the steps of the depicted flow charts need be practiced; various embodiments of the present invention may be practiced with fewer, additional, and/or substituted steps. For example, an automated greeting may not be implemented in some embodiments.

At step 605, the system determines that a customer is at a menu board. For example, a vehicle sensor detects a vehicle has pulled up to a drive-through menu board. At step 610, an automated greeting is output at the menu board location. For example, the menu board may comprise a display screen and audio speaker that may be used to output an audio and/or video greeting to the customer. In some embodiments, a customer offer device may be used for outputting a greeting. The greeting may include a standard message (e.g., “Welcome to Sal's!”) and/or a passive or active type of offer, and may include content customized for the customer (e.g., an indication of the customer's favorite order, a “Happy Birthday!”message).

For example, as will be readily understood by those skilled in the art, some types of systems may be operable to identify a customer, such as by receiving a signal from a customer device (e.g., wireless phone, personal digital assistant) or identifying the customer's vehicle. A system that, among other things, enables the collection and maintenance of information related to a customer, and which is appropriate for use in some embodiments of the present invention, is disclosed in U.S. patent application Ser. No. 10/124,697, filed Apr. 16, 2002, entitled “METHOD AND APPARATUS FOR MAINTAINING A CUSTOMER DATABASE USING LICENSE PLATE SCANNING,” the entirety of which is incorporated by reference herein for all purposes.

In step 615, an order is received from the customer. For example, the customer interacts with an employee to place an order via a microphone and a speaker. The employee may enter the order in a POS terminal, in a manner well known in the art. In step 620, the system determines a subtotal of the order. For example, the offer server (e.g., or other server performing various POS functions) calculates a subtotal of the order based on the ordered items, or receives an indication of the subtotal from an employee or POS system.

In step 625, the system outputs an upsell offer. For example, based on the order, the offer server determines an appropriate offer and transmits the offer to a customer offer device for output to the customer at the menu board. In another example, the offer server determines that an offer should be output and signals an instruction to the menu board to output an upsell offer (e.g., the menu board may store one or more offers). In at least one embodiment, the system is operable so that the customer may accept or decline the offer verbally. For example, the customer may respond using a microphone, and the response is heard by an employee. In another example, the customer's verbal response may be analyzed by a voice response unit to determine whether or not the customer accepted the offer, in a manner well known in the art. In another example, the customer may respond using an appropriate button on a keypad or touch screen.

In step 630, the system determines that the customer has moved away from the menu board. As discussed herein, this may comprise a sensor detecting that the customer (or the customer's vehicle) has moved, or determining that the customer (or the customer's vehicle) is no longer detected. In some instances, determining that the customer has moved away may comprise determining that the customer is present at a different station and/or determining that a different customer or vehicle is detected at the menu board.

In step 635, the system discontinues output of the upsell offer. Discontinuing output may comprise determining whether the output of the offer has completed (e.g., by reference to the transaction database 430), whether the offer has been accepted, and/or whether output of the offer has even begun. For example, outputting the offer may comprise signaling to a customer offer device to commence output, but the customer may have pulled away from the menu board before the output began. If output of the offer has not even started, discontinuing output may comprise suppressing the output, for example, by signaling an output device not to output the offer.

Discontinuing may also comprise determining whether to discontinue the offer. For example, some types of offers, such as passive or promotional offers, may be allowed to continue, even if they might be viewed by a subsequent customer, because their content is not specific to a particular transaction or is generally appropriate for many types of customers. As discussed herein, offer database 425 may include an indication of whether a particular offer should be terminated.

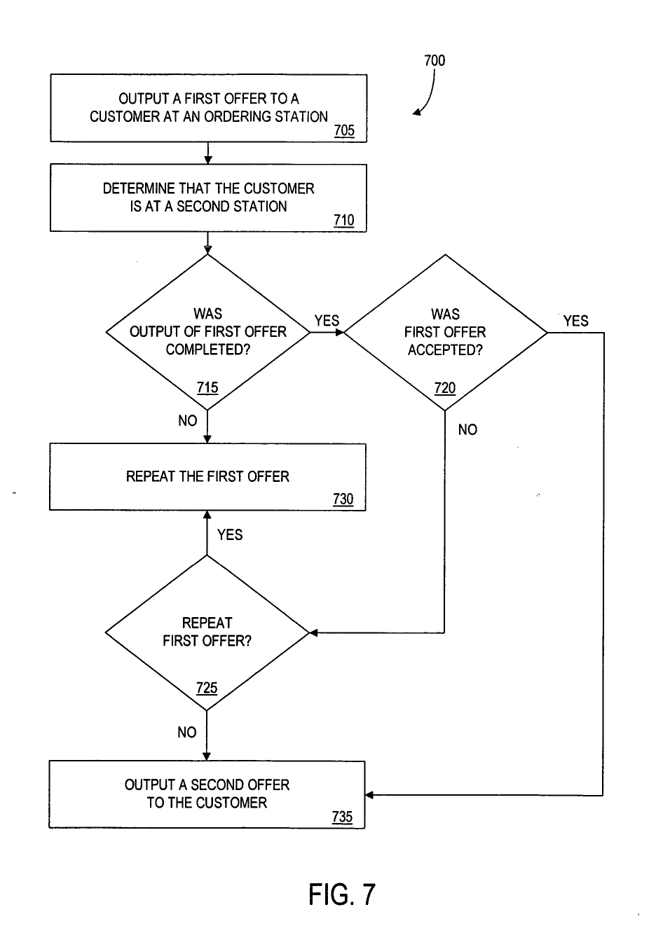

Referring to FIG. 7, a flow chart 700 represents one embodiment of the present invention that may be performed by the system 100 and/or the offer server 105, for example, in controlling the providing of offers in a retail drive-through having two or more stations and/or two or more customer offer devices.

In step 705, a first offer is output to a customer at an ordering station (e.g., an order window, a menu board). In step 710, the system determines that the customer is at a second station. Various ways of tracking the location, presence, absence and/or motion of a customer are discussed herein. For example, after placing an order at a menu board, a customer may drive his vehicle forward to a payment window or pick-up window. The customer's presence at the second location may be detected by one or more sensors and/or may be indicated by a cashier or other employee. In some embodiments, the customer's order may be retrieved from a queue or other stored indication of customer orders (e.g., the transaction database 425).

In step 715, the offer server determines whether output of the first offer was completed (e.g., at the first station). The offer server may refer to the transaction database 425, for example, in making this determination.

In step 720, if the first offer was completed at the first station, it is determined whether the customer accepted the first offer. If so, the process may optionally proceed to step 735, in which a second offer is output to the customer. Alternatively, the process may end.

If the first offer was not accepted, in step 725 the system determines whether to repeat the first offer. For example, if the customer actively declined the offer (e.g., by saying “No”), the system may determine not to repeat that offer. In another example, if the customer just drove away after the offer ended, then the offer might be repeated. Various rules and criteria may be considered in determining whether to repeat a particular offer, some of which are discussed herein (e.g., speed of service); other considerations will be readily apparent to those having ordinary skill in the art in light of the present disclosure.

If it is determined not to repeat the first offer, then the process may optionally proceed to step 735, in which a second offer is output to the customer. Alternatively, the process may end.

If the first offer was not completed (e.g., if the customer moved away from the menu board, ordering station, or customer offer device used to output the first offer), then in step 730 the first offer is repeated at the second station (e.g., by a cashier, via a second customer offer device). Alternatively, of course, a different offer could be output, or no offer could be output at all at the second station.

As will be readily understood by those of skill in the art, the second station may be used for various types of functions, including receiving payment from a customer, providing change due to the customer, and delivering a purchase (e.g., a food order) to the customer.

The following are several examples that illustrate some embodiments of the present invention. These examples do not constitute a definition of all possible embodiments, and those skilled in the art will understand that the present invention is applicable to many other embodiments. Further, although the following examples are briefly described for clarity, those skilled in the art will understand how to make any changes, if necessary, to the above-described apparatus and methods to accommodate these and other embodiments and applications.

According to one embodiment of the present invention, a drive-through of a quick service restaurant can include one or more customer offer devices to provide offers in visual and/or audio form. Transaction slots or other appropriate times for making an offer to a customer can be defined, for example, by a vehicle's position (e.g. at the main menu at the beginning of the drive-through, at the payment window, at the food pick-up window). The position of the vehicle may be determined, as discussed herein, by weight or metal sensors on the drive path and/or based on data entered by cashiers into the POS terminal at particular times during the transaction (e.g., when the customer drives up to the pick-up window).

In such an embodiment, various inputs from the customer can be interpreted by the offer server. For example, if a customer drives away from the first station before an audio offer is completely provided, or before a visual offer is displayed for a predetermined period of time, the offer is considered to be declined and/or not completed. When an offer is declined in this way, the same offer may be provided again, for example, when the customer reaches the payment window by a customer display device at the payment window. Alternatively, when an offer (e.g. a product in lieu of change due) is declined in this way, a related offer (e.g. a coupon in lieu of change due) may be provided again when the customer reaches the payment window. If such an offer is not declined, then an advertisement may instead be displayed to the customer at the payment window. Alternatively, if the customer declines an offer at the menu board, an offer with a deeper discount may be made at the payment window. Finally, these alternatives may be used in any combination. For example, after a declined offer at an order window, a coupon with a deeper discount may be offered at the pick-up window.

According to one exemplary embodiment, a suggestive selling system is linked to a motion sensor (or other type of detector) in the drive-through of a quick serve restaurant. When a cashier enters a “Subtotal” button (or any other key which triggers the provision of an offer) on the POS terminal corresponding to the drive-through, the system generates an upsell offer. The upsell offer is output to the customer, e.g., via a digital display and audio output speakers built into the drive-through menu board, order confirmation board or other device situated at the drive-through ordering station. If the system detects that the customer's car has moved from the drive-through menu board ordering station, it automatically discontinues making the suggestive sell.

According to another exemplary embodiment, the POS terminal stores a customer's order and retrieves it when the customer drives up to one or more of the windows for food delivery and/or money tendering. Optionally, an additional screen at the pick up window can display any declined or discontinued offer to the customer again. For example, the customer may have declined an upsell at the menu board or drove up before the upsell had been completely output by the menu board. If, on the other hand, the customer accepted the upsell during the ordering process, this second display can be used to confirm the upsell and/or for any other communications or marketing purposes, including displaying the customer's order in its entirety or indicating an amount of change due, if any.

According to at least one embodiment, a process is provided for providing an upsell offer to a customer. In an exemplary process, a restaurant server receives an indication of a customer order. For example, a customer gives her order to a point-of-sale cashier via a menu board, who enters the order at a point-of-sale terminal. An offer server determines whether an upsell offer should be provided to the customer via a digital menu board. In some embodiments, the offer server determines whether to provide an upsell offer.

Various embodiments of the present invention are related to the providing of upsells to customers once they have placed an order. One example of a process for providing an upsell at a restaurant is as follows:

1. A customer places her order (e.g., at a drive-through menu)

2. The system figures out how much change is needed to round up the purchase to the nearest whole dollar

3. The system generates an offer of the choice between two food items in lieu of the change amount

4. The system presents the offer on a digital screen as well as via an audio recording (e.g., at the drive-through menu board).

5. If the customer accepts the offer, the system adds the item to the order and rounds up the purchase.

Various embodiments of the present invention allow a menu board or other type of customer offer device to output multiple types of suggestive sell offers (e.g., after a customer has placed an order). Some offer types are depicted in the exemplary data of FIG. 4. Some other examples of offer types include, without limitation:

1. Spare Change Upsell. A customer is offered the choice between at least two items in exchange for the coin change needed to round up their purchase to the nearest whole dollar, nearest whole $2 or any other round up amount.

2. Coupon or Item Spare Change Upsell. The customer could be offered the choice between an item, and a coupon for that item. The offer could be for a fixed amount or for the change needed to round up the purchase (or at the full menu board price).

3. Multiple Rounding Amount Upsell. The customer could be offered the choice of rounding his total to one amount to get one item or rounding his total to another amount to get another item.

4. Coupon Upsell. The customer is offered a coupon for an item or a discount off either for the change needed to round up their purchase, or for a fixed amount.

5. Coupon Pack Upsell. The customer is offered a pack (multiple) of coupons that are complimentary (or competitive) to her order for a fixed price or for the change needed to round up her purchase (site disclosure)

6. Multiple Choice Full Price Upsell. The customer is offered the choice between at least two items for a fixed price, which may be the full retail price of the items.

7. Full Price Complimentary Item Upsell. An item could be offered to the customer that compliments their existing order. The item could be for the full retail price, a fixed price, or for the change needed to round up the purchase.

8. Super size Upsell (full price or for change). The customer could be offered the chance to “super-size” their meal or a portion of their meal for a fixed amount or for the change needed to round up their purchase.

9. Item Replacement Upsell (full price or change). “Change” could in some embodiments be an even dollar or other increment, e.g., $0.25. The customer could be offered the chance to replace an item in their order with a different item. The upsell could be for a fixed price, for free, or for the change needed to round up the purchase.

10. Survey. The customer could be asked to answer a few questions. The customer's response could be recorded via an audio input or via a touch screen.

11. Single Item Upsells. The upsell could be an offer for a single item for a fixed price or in exchange for rounding up the purchase.

12. % Discount Off Upsell. Rather than an offer for one or more items to round up the order, the system could make offers for items a certain random discount off of the regular retail for those items. For instance, a customer could be offered the chance to buy a small fry or an apple pie at 23% off of the original retail price (or some other percentage off between a fixed minimum and maximum, determined according to a rules, database and/or adaptive method, or at random).

13. Lottery ticket. An upsell can be made for a full price or rounded (e.g., fractional) price lottery ticket.

14. Cross-sell. The customer could be offered part or all of her meal if she elects to participate in a “cross sell” (where a third party subsidizes some or all of the meal in exchange for the customer participating in some transaction with the third party).

15. Competitive offer. The customer may be given an offer for a coupon for a competitive product, such as the same type of item from a different manufacturer. Could be, but need not necessarily be, a coupon for a product in a grocery store.

16. Subscription. The customer might be offered a discount on this transaction if they agree to purchase a certain number of additional items in the future.

17. Upsell with Order confirmation. Any of these upsells can also be presented with the customers order total and order contents. For example, as discussed herein, an upsell could be presented at a payment and/or pick-up window.

18. Combinations. Any one upsell may be offered along with a similar or different upsell offer. Any two (or more) combinations of any or all of the above upsell types may be combined to create compelling and unique offers.

### 4. Additional Embodiments

According to some embodiments of the present invention, a motion sensor or other type of customer detector can control any type of post-order suggestive selling in a drive-through system.

In some embodiments, the determination as to whether to provide the offer and/or whether to provide the offer via a customer offer device is based on the customer order.

Some embodiments of the present invention provide for a display device such as a digital menu board or customer offer device to receive an indication of an upsell offer and display a representation of the upsell offer. For example, a digital menu board system may receive an offer code that corresponds to a particular upsell offer. The system may then retrieve display content corresponding to the offer/offer code, and display the corresponding content (e.g., a video/audio presentation of the offer).

One or more embodiments of the present invention provide for a system operable to update an offer/advertisement slot. According to some embodiments, an offer server determines an upsell/advertisement type. For example, a restaurant server may determine to output a particular advertisement, and identifies the type of advertisement. In another example, a server receives or otherwise determines a type of advertisement to display, and optionally determines an advertisement of that type to display (e.g., selected from a database of display content). An upsell/advertisement slot is also determined, for example, based on the determined type of upsell/advertisement. For example, it may be preferred to display video content at one particular slot of a digital menu board. In another example, content that is predominantly text-based might be displayed at a different slot and/or at a different display device. The upsell/advertisement is output at the determined slot. For example, an indication of the display slot and/or the content to be displayed is transmitted to a digital menu board.

Systems and methods which, among other things, provide for the use of electronic display devices to provide offers and advertisements, and which are appropriate for use in accordance with the present invention is disclosed in pending U.S. patent application Ser. No. 10/770,385, filed Feb. 2, 2004, entitled “DIGITAL ADVERTISEMENT BOARDS IN COMMUNICATION WITH POINT-OF-SALE TERMINALS,” the entirety of which is incorporated herein by reference as part of the present disclosure.

Although the discussion herein refers frequently to drive-through systems, it will be readily understood that various embodiments of the present invention may be practiced in different environments. For example, many aspects of the present invention may be applicable to any retail service process in which a customer moves from an ordering station and/or approaches a pick-up or payment station. For instance, a customer self-ordering kiosk may be configured so as to terminate output of an upsell offer if the customer moves away from the kiosk (e.g., to pick up his order, to tender payment).

According to some additional embodiments of the present invention, a sensor may be placed at a drive-through pick-up window (or payment window) and the system configured so that an upsell cannot be retrieved and/or presented to the customer unless the customer has been detected at the pick-up window.

As discussed above, the system may be operable to provide a greeting and other types of messages. According to some embodiments, a sensor may be used to control other types of communications activities, e.g., a greeting with an pre-order promotion, based upon the time of day, day of week, current sales volume, and/or any other type of sales or revenue management information.

According to some embodiments, a sensor and a timing device (e.g., a clock) can be used to manage whether or not an upsell can be made on a particular transaction based on various criteria, such as speed of service times or revenue per hour measurements. For instance, when the system determines that sales exceed a certain threshold per hour, it can elect to only make a suggestive sell offer at the drive-through menu board, at the pick up window, or simply not make an upsell at all.

According to one alternative embodiment, an audio sensor installed in the customer offer device (e.g., at the menu board, at the pick up window) can adjust the volume of an audio suggestive sell based on the detected ambient noise near an audio device.

According to some embodiments, offers and other types of communications can be presented in audio and/or video format at any type of customer offer device based on user preferences.

According to some embodiments of the present invention, various performance measures in a drive-through embodiment that may be collected and used in the providing of future offers include: the time the customer waits at the main menu, at the payment window, and at the food pick-up window, or when/if the cashier accepts or declines an offer. Such times can be stored, and can be displayed to employees working at the quick service restaurant during and/or after the transaction. Similarly, such times can be displayed to the customer, possibly in conjunction with a promotion such as a free or discounted product, coupon, or entire order is earned if a particular time exceeds a predetermined threshold.

While the method and apparatus of the present invention have been described in terms of its presently preferred and alternate embodiments, those skilled in the art will recognize that the present invention may be practiced with modification and alteration. The specifications and drawings are, accordingly, to be regarded in an illustrative rather than a restrictive sense. Further, even though only certain embodiments have been described in detail, those having ordinary skill in the art will certainly appreciate and understand that many modifications, changes, and enhancements are possible within the scope of the accompanying claims. All such modifications are intended to be encompassed within the following claims.

What is claimed is:

1. A method comprising:
sensing that a customer is at a menu board of a drive-through;
outputting an automated greeting using the menu board;
receiving an order from the customer;
determining a subtotal of the order;
determining an offer based on the subtotal;
initiating output of the offer using the digital menu board;
sensing that the customer has moved away from the menu board; and
automatically terminating output of the offer in response to sensing that the customer has moved away from the menu board.

2. A method comprising:
determining that a customer is at an ordering station;
receiving an order of the customer at the ordering station;
outputting a first offer at the ordering station;
determining that the customer is at a second station; and
outputting a second offer at the second station.

3. The method of claim 2, in which determining that a customer is at an ordering station comprises:
detecting a vehicle.

4. The method of claim 2, in which the second offer is the same as the first offer.

5. The method of claim 2, in which the second offer is different than the first offer.

6. The method of claim 2, further comprising:
terminating output of the first offer before the first offer is completed.

7. The method of claim 2, further comprising:
receiving an indication that the customer is not at the ordering station; and
automatically terminating output of the first offer in response to receiving the indication that the customer is not at the ordering station.

8. The method of claim 2, further comprising:
determining the first offer based on the order.

9. The method of claim 8, in which determining the first offer comprises:
determining a subtotal of the order; and
determining the first offer based on the subtotal.

10. The method of claim 8, in which determining the first offer comprises:
determining at least one item in the order; and
determining the first offer based on the at least one item.

11 The method of claim 2, in which the first offer comprises an upsell offer.

12. The method of claim 2, in which the first offer comprises an offer for an item in exchange for an amount of change due.

13. The method of claim 2, in which the second station is a pick-up station.

14. The method of claim 2, in which the second station is a payment station.

15. The method of claim 2, further comprising:
determining the second offer based on the first offer.

16. The method of claim 2, further comprising:
receiving a response to the first offer; and
determining the second offer based on the response to the first offer.

17. The method of claim 2, further comprising:
determining whether the first offer was accepted; and
determining the second offer based on whether the first offer was accepted.

18. The method of claim 2, further comprising:
determining whether the first offer was completed; and
determining the second offer based on whether the first offer was completed.

19. The method of claim 2, in which the ordering station comprises a menu board.

20. A method comprising:
initiating output of a first upsell offer to a customer at an ordering station;
determining if the customer left the ordering station before output of the first upsell offer was completed;
if the customer left the ordering station before output of the first upsell offer was completed,
outputting a second upsell offer to the customer at a second station.
